(19) United States
(12) Patent Application Publication
(10) Pub. No.: US 2012/0133555 A1
(43) Pub. Date: May 31, 2012

(54) METHOD AND SYSTEM FOR BUILDING LOCATION INFORMATION DATABASE OF ACCESS POINTS AND METHOD FOR PROVIDING LOCATION INFORMATION USING THE SAME

(75) Inventor: Moon Pil HYUN, Gyeonggi-do (KR)

(73) Assignee: SAMSUNG ELECTRONICS CO., LTD., Gyeonggi-Do (KR)

(21) Appl. No.: 13/307,161

(22) Filed: Nov. 30, 2011

(30) Foreign Application Priority Data
Nov. 30, 2010 (KR) 10-2010-0120484

(51) Int. Cl. G01S 19/48; G01S 5/02

(52) U.S. Cl. 342/357.31; 342/451

(57) ABSTRACT

A method and system for building a database (DB) of location information of APs and providing AP location information in a shadow area of Global Positioning System (GPS) using the DB includes acquiring a reference location during a location information acquisition mode; collecting AP information of at least one AP by a mobile terminal by scanning periodically; calculating AP scan location where AP scan is executed; calculating AP location of the at least one AP using the AP information and the AP scan location; and building the AP location information DB by listing a mapping of the AP location to AP information.

### CLAIM OF PRIORITY

This application claims the priority under 35 U.S.C. §119(a) of an application filed in the Korean Intellectual Property Office on Nov. 30, 2010 and assigned Serial No. 10-2010-0120484, the contents of which are hereby incorporated by reference.

### BACKGROUND OF THE INVENTION

1. Field of the Invention

The present invention relates to a location information database (DB) building method for an Access Point (AP), in particular, to a method and system for building a DB including location information of APs and using the DB to provide location information.

2. Description of the Related Art

With a rapid advance in information and semiconductor technologies, there has been a phenomenal growth in the use and popularity of mobile devices. In addition to data and voice communication, mobile devices now provide a multi functions and services including a television (TV) function, (e.g., Digital Multimedia Broadcasting (DMB) and Digital Video Broadcasting (DVB)), an audio playback function (e.g. MPEG Audio Layer-3 (MP3)), a camera function, a data communication function, an Internet access function, and a location information provision function.

The location information provision function provides users with a current location using GPS. However, the GPS-based location information service has a drawback in that the location accuracy degrades in GPS shadow area such as inside of building, basement, and tunnel where the GPS signal cannot reach. To address this problem, a recent positioning system is provided with an additional assistant means.

Meanwhile, with a widespread use of portable devices (such as laptop computer, Smartphone, Personal Digital Assistant (PDA), and tablet PC) equipped with a WLAN (e.g. Wi-Fi) module, a Wi-Fi Positioning System (WPS) is drawing attention as a promising method for providing location information using WLAN signals. Similar to GPS using satellite signal to locate the position of a mobile terminal, WPS is a technique to locate a mobile station based on the identity information of a WLAN AP (e.g. MAC address) or signal strength of the AP. In case of WPS, it is necessary to build a database (DB) of the location information of APs.

In order to build the AP location information DB, the conventional WPS use a vehicle having the equipment capable of receiving AP signal and GPS signal to scan adjacent APs on the move and acquires the information on the AP-scanned locations using the AP identity information (MAC address) of the adjacent APs and GPS signals. However, since the conventional WPS acquires the location at which the AP signal is scanned using the GPS signal, it is difficult to acquire the accurate location information in the GPS shadow area, thus resulting in degradation of reliability of the AP location information DB.

### SUMMARY OF THE INVENTION

The present invention has been conceived to solve the aforementioned problems by providing an AP location information DB building method and a system that is capable of building an AP location information DB with accurate location information of the APs, especially the APs located in the GPS shadow area.

One aspect of the present invention is to provide an AP location information DB building method and a system that is capable of measuring locations of the AP-scanning positions and calculating the locations of the APs based on the measured location information using a Dead Reckoning (DR) algorithm.

Another aspect of the present invention is to provide a method for improving the reliability of the location information service using the AP location information DB, which provides accurate location information even in the GPS shadow area.

It is still another aspect of the present invention to provide a method for providing location information and improving the reliability of the location information service seamlessly in both the outdoor and indoor environments using accurate AP location information especially in the GPS shadow area.

In accordance with an aspect of the present invention, a method for building an Access Point (AP) location information database (DB) to provide location information in a Global Positioning System (GPS) shadow area includes: acquiring a reference location during a location information acquisition mode; collecting AP information of at least one AP by a mobile terminal by scanning periodically; calculating AP scan location where AP scan is executed; calculating AP location of the at least one AP using the collected AP information and the AP scan location; and building the AP location information DB by mapping the AP location to AP information.

In accordance with another aspect of the present invention, a system for building an Access Point (AP) location information database (DB) to provide location information in a GPS shadow area includes: a mobile terminal which scans to collect AP information of at least one AP in the GPS shadow area and calculates AP scan location where the AP scan is executed; and a location server which builds the AP location information DB using AP location derived from the AP information and AP scan location

In accordance with still another aspect of the present invention, a method for providing location information using an Access Point (AP) location information database (DB) having location information of APs deployed in a Global Positioning System (GPS) shadow area includes: determining, when a road guidance mode is executed, whether a GPS signal is received; scanning, when no GPS signal is received, to discover a nearby AP by activating a Wireless Local Area Network (WLAN) unit; collecting, when at least one AP is discovered, AP information of the at least one AP; and providing location information of a mobile terminal by comparing the collected AP information and the AP information stored in the AP location information DB.

### BRIEF DESCRIPTION OF THE DRAWINGS

FIG. 1 is a schematic diagram illustrating a system for building a database of location information of access points according to an embodiment of the present invention;

FIG. 2 is a block diagram illustrating a configuration of a mobile terminal according to an embodiment of the present invention;

FIG. 3 is a flowchart illustrating a method for locating APs in a GPS shadow area according to an embodiment of the present invention;

FIG. 4 is a diagram illustrating the principle of locating an AP deployed in a GPS shadow area using triangulation according to an embodiment of the present invention; and

FIG. 5 is a flowchart illustrating a method for providing location information according to an embodiment of the present invention.

### DETAILED DESCRIPTION OF THE INVENTION

Exemplary embodiments of the present invention are described with reference to the accompanying drawings in detail. The same reference numbers are used throughout the drawings to refer to the same or like parts. For the purposes of clarity and simplicity, detailed description of well-known functions and structures incorporated herein may be omitted to avoid obscuring the subject matter of the present invention.

The specification and drawings are to be regarded in an illustrative rather than a restrictive sense in order to help understand the present invention. It is obvious to those skilled in the art that various modifications and changes can be made thereto without departing from the broader spirit and scope of the invention as set forth in the appended claims.

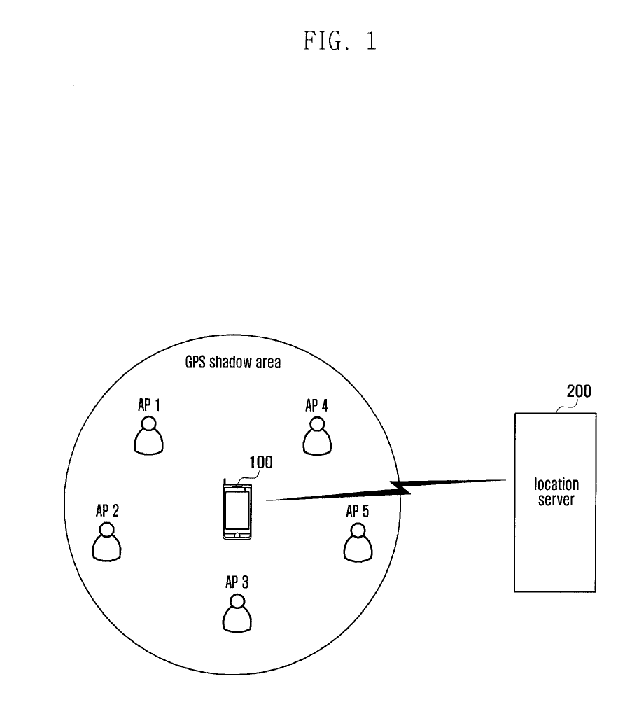

FIG. 1 is a schematic diagram illustrating a system for building a database relating to location information of access points according to an embodiment of the present invention.

Referring to FIG. 1, the AP location information DB building system according to an embodiment of the present invention can include a mobile terminal 100, a location server 200, and a plurality of APs (AP1, AP2, AP3, AP4, and AP5).

In operation, the mobile terminal 100 locates the position of nearby APs in a GPS shadow area (e.g. indoor environment such as department store, subway, and shopping mall) and transmits the AP location information to the location server 200 in order to build the AP location information DB.

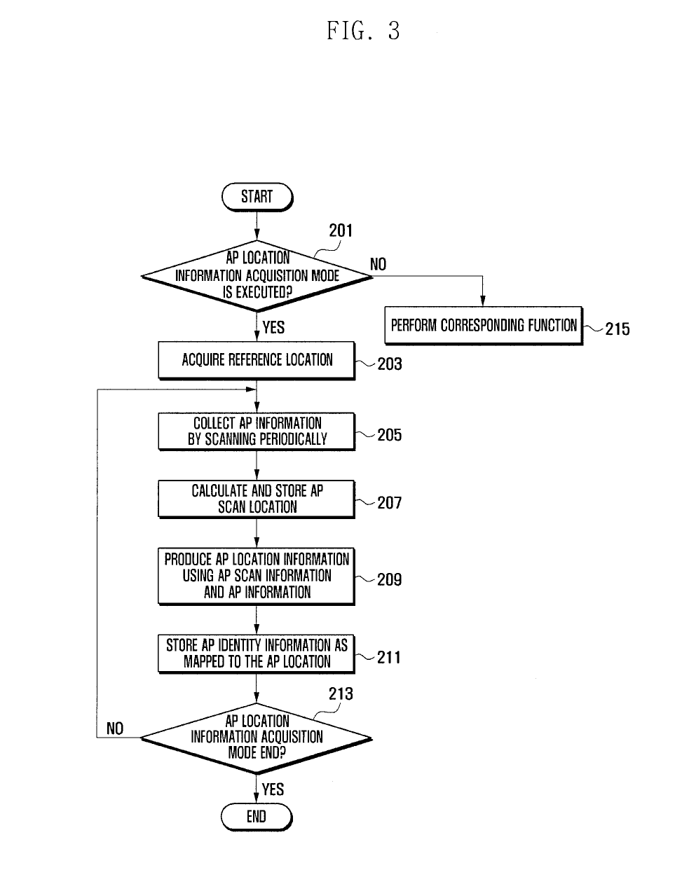

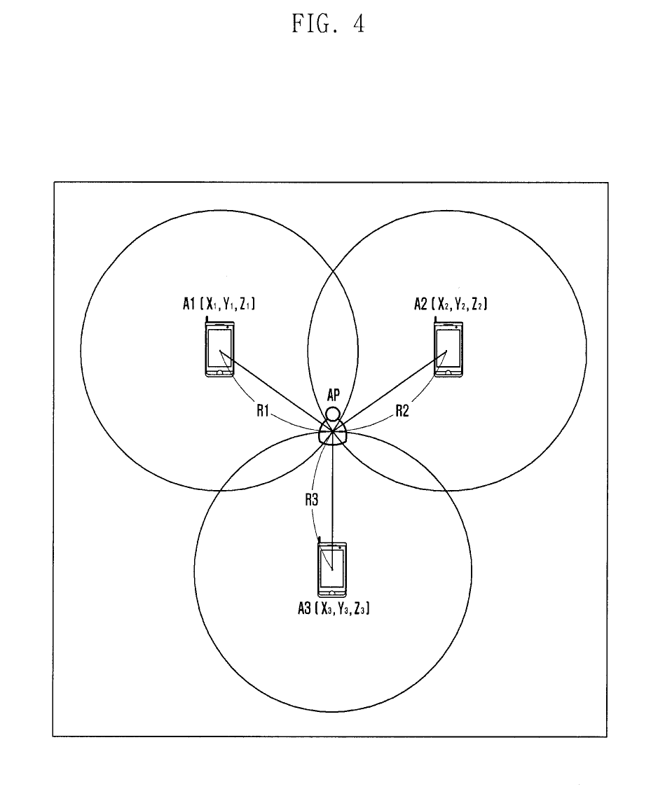

In order to locate APs, the mobile terminal 100 collects signals related to an AP scan location, Received Signal Strength Indicator (RSSI), and AP's IP identity address (e.g., MAC address) during an the AP location information acquisition mode. Here, the mobile terminal 100 acquires the AP scan location using Dead Reckoning (DR). DR involves calculating one's current position based on the movement direction and speed of the mobile station 100 that are measured using sensors and a reference location information. Since the dead reckoning process is well known, a detailed description thereof is omitted herein. A detailed process of locating the AP scan location will be described later with reference to FIGS. 3 and 4.

Once the AP location information DB is generated which contains data relating to a mobile location and the corresponding AP IP identify address and the RSSI for a plurality of APs, the mobile terminal 100 can obtain the location information of AP in the GPS shadow area by looking up the AP location information DB. That is, if location information is requested, the mobile terminal 100 sends the location server 200 the approximate location information of its current position and in turn receives the AP location information DB from the location server. Using the AP location information DB, the mobile terminal 100 can retrieve the location information of the nearby AP in the GPS shadow area using its approximate location information. Further, the mobile terminal 100 can sends the location server 200 the information on the AP identity information and RSSI of an AP scanned therearound and in turn receive the location information of the mobile terminal 100 using the AP location information DB.

The location server 200 can build the AP location information DB using the AP location information transmitted by the mobile terminal 100. That is, the location server 200 can produce the location information of the AP based on the identity information, RSSI of the AP, and the AP scan location by mapping the corresponding AP location scan information, AP identity information, and RSSI. Thus, the location server 200 can search the AP location information DB for AP location information for a particular AP identity information. Further, when a new AP detected, the new AP is updated by registering the new AP in the AP location information DB.

Moreover, the location server 200 produces current location information of the mobile terminal 100 using the identity information of at least one AP that is transmitted by the mobile terminal 100 and calculate the current location of the mobile terminal 100 from referring to the AP location information DB, then sends the determined current location information to the mobile terminal 100. Note that the location server 200 can be provided by the mobile carrier or a Wi-Fi Positioning System (WPS) service provider.

It should be noted that the illustrative embodiment is directed to a system where the AP location information DB is stored in the location server 200 remotely. However, the present invention is not limited thereto. For example, the AP location information DB can be stored in a storage unit of the mobile terminal 100. In this case, the mobile terminal 100 can have the capability of calculating the AP location using the identity information and RSSI of the AP and AP scan location information. Alternatively, the AP location information DB can be stored in a local server installed in a building such as department store and shopping mall. In this case, when the mobile terminal enters the building, the mobile terminal can receive the AP location information DB via the WLAN deployed in the building. The mobile terminal 100 also can receive the AP location information DB related to the corresponding area from another mobile terminal or transmit its own AP location information DB to another mobile terminal.

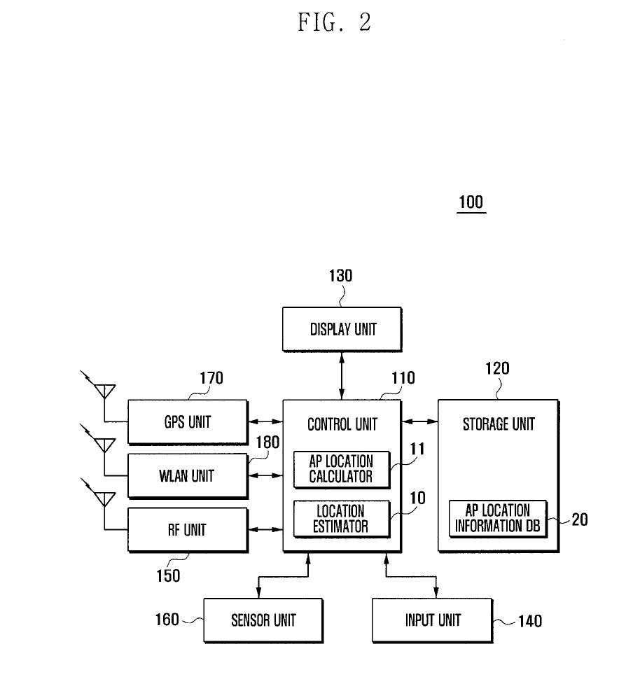

FIG. 2 is a block diagram illustrating a configuration of a mobile terminal according to an embodiment of the present invention.

Referring to FIG. 2, the mobile terminal 100 according to an embodiment of the present invention includes a control unit 110, a storage unit 120, a display unit 130, an input unit 140, a Radio Frequency (RF) unit 150, a sensor unit 160, a GPS unit 170, and a WLAN unit 180. The control unit 110 can include a location estimator 10 and an AP location calculator 11, and the storage unit 120 can include AP location information DB 20.

The display unit 130 displays various menus of the mobile terminal 100 and information input by or to be provided to the user. For example, the display unit 130 can output various screens, e.g. standby screen, message composition screen, and call progress screen. The display unit 130 also can display a location information provision screen. The location information provision screen can be a road guidance application execution screen. Particularly in an embodiment of the present invention, the display unit 130 is capable of displaying the guidance information in the GPS shadow area where the GPS signal is not received, i.e. indoor environment such as department store and shopping mall and subway. The display unit 130 can be implemented with one of Liquid Crystal Display (LCD), Organic Light Emitting Diode (OLED), and Active Matrix OLED (AMOLED). In case that the display unit 130 is equipped with touchscreen functionality, the display unit 130 can operate as a part of the input unit 140.

The input unit 140 generates signals to the control unit 110 in response to various alphanumeric character inputs and function setting and execution inputs. The input unit 140 is provided with a plurality of alphanumeric keys for receiving the alphanumeric inputs and function keys for receiving the function setting and execution inputs. The function keys can include navigation keys, side keys, and shortcut keys configured for executing specific functions. For example, the input unit 140 can include a call key for making a call, an end key for terminating a call, and a hold key for holding the call. The input unit 140 can be implemented at least one of a touchpad, a touchscreen, a normal keypad, and a QWERTY keypad.

The RF unit 150 can establish a communication channel with a bases station for voice and data communications (including video communication). For example, the RF unit 150 can transmit and receive voice and video signals to and from a counterpart terminal under the control of the control unit 110. The RF unit 150 can includes an RF transmitter (not shown) for up-converting and amplifying transmission signals, an RF receiver (not shown) for low noise amplifying and down-converting received signals, and a transmission/reception isolator (not shown) for isolating transmission and reception. Particularly in an exemplary embodiment where the AP location information DB 20 is stored in the location server 200, the RF unit 150 can send the location server 200 the AP identity information (e.g., MAC address) of the APs located in the GSP shadow region that are determined by the AP location calculator 11. Further, the RF unit 150 can further transmit the RSSI and AP scan location information to the location server 200.

The RF unit 150 can transmit the approximate information of the current location to the location server 200 in response to a location information request and receives the AP location information DB related to the corresponding location from the location server 200, such that the received AP location information DB is stored in the storage unit 120. In case that the location information is provided by the location server 200, if the mobile terminal 100 enters a GPS shadow area, the RF unit 150 transmits the AP information (AP identity information and RSSI) collected by means of the WLAN unit 180 to the location server 200 under the control of the control unit 110 and in turn receive the information on the current location of the mobile terminal 100 that is produced based on the collected AP information.

The sensor unit 160 senses the movement speed and direction of the mobile terminal 100 and sends the sensed information to the location estimator 10 of the control unit 110. The sensor unit 160 can include an acceleration sensor (not shown) for measuring a movement speed of the mobile terminal 100, a Gyroscope, and other sensors for locating and compensating the position of the mobile terminal. Particularly in an embodiment of the present invention, the sensor unit 160 can be configured to be activated automatically when the mobile terminal 100 enters a GPS shadow area. The sensor unit 160 also can be configured to be activated during the AP location information acquisition mode. Since the sensor unit 160 is provided for locating the AP scan location information, i.e. determining reference location, it can be omitted when the mobile terminal 100 does not support DR. In this case, the reference location can be computed by looking up the measured AP information (AP identity information and RSSI) from the previously stored AP location information DB 20. The reference location computation process will be described later along with the explanation on the location estimator 11 of the control unit 110.

The GPS unit 170 provides the GPS signal received from the GPS satellite to the control unit 110. The GPS signal is weaken in the indoor environment, i.e. in a building, basement, and tunnel. Since the GPS-based location information technologies are well known to those skilled in the art, detailed description thereon is omitted herein.

The WLAN unit 180 can transmit and receive radio signals to and from at least one AP within a predetermined range. Particularly in an embodiment of the present invention, the WLAN unit 180 collects the AP information (identity information and RSSI) periodically during an AP location information acquisition mode, or according to the signal input through the input unit 140. In case that the local server installed in a department store or a shopping mall provides the information on the locations of AP installed in the building, the WLAN unit 180 can receive the AP location information DB of the corresponding building from the local server. The WLAN unit 180 can transmit and receive radio signal in a specific radio communication technology such as Wi-Fi, WiMax, and WiBro.

The storage unit 120 can store the programs necessary for the operations related to the method according to an embodiment of the present invention and user data. The storage unit 120 can include a program region and a data region. The program region stores programs controlling the general operations of the mobile terminal and Operating System (OS) for booting the mobile terminal 100, application programs for playing multimedia contents and executing the supplementary functions of the mobile terminal 100 such as camera function, audio playback function, and still and motion picture playback function. Particularly in an embodiment of the present invention, the program region can store the program for calculating the location of the mobile terminal 100 based on the movement speed and direction of the mobile terminal 100 that are measured by the sensor unit 160. The program region can store the program for computing the location of the AP using the location information of the mobile terminal 100 that is calculated based on the AP information periodically or according to an input signal in the GPS shadow area and the location information of the mobile terminal 100 calculated by the sensor unit 160. The AP location calculation process will be described later in detail with reference to FIG. 3. The program region also can store the program for calculating the distance between the mobile terminal 100 and AP based on the received signal strength of the AP.

The data region stores the data generated as the result of the operation of the mobile terminal 100 such as phonebook, audio data, and information related to the corresponding contents and user data. Particularly in an embodiment of the present invention, the data region can include the AP location information DB 20 storing the AP scan location information and the identity information and RSSI of the AP.

As explained earlier, the AP location information DB 20 is used to produce the location information of the mobile terminal especially when the mobile terminal 100 enters a GPS shadow area. Thus, the present invention is capable of locating a specific position of the mobile terminal 100 by comparing the AP's identity information and RSSI measured by the WLAN unit 180 with the identity information and RSSI pre-stored in the AP location information DB 20.

In case that the AP location information DB 20 is stored in the location server 200, which provides the location information service based on the AP information, the data region can store the address of the location server 200. The address of the location server 200 can be used for the mobile terminal 100 to transmit the AP information collected during the AP location information acquisition mode for building the AP location information DB 20. The address of the location server 200 also can be used for transmitting AP information collected for locating the current position of the mobile terminal 100.

The control unit 110 controls overall operations of the mobile terminal 100 and signaling among the internal function blocks of the mobile terminal 100. Particularly in an embodiment of the present invention, the control unit 110 acquires reference location information when the mobile terminal 100 enter the AP location information acquisition mode in the GPS shadow region, collects the information of at least one AP periodically as well as location information of the mobile terminal 100 during that time. The location information of the mobile terminal 100 can also be collected according to a signal input thorough the input unit 140 by activating the sensor unit 160 and the WLAN unit 180. Note that the reference location can be the last position at which the GPS signal is received before entering the GPS shadow area. The reference location also can be the coordinate information input by the user.

Thereafter, the control unit 110 computes the location information of an AP using the location information of the mobile terminal 100 and the collected information on at least one AP (hereinafter “AP information”). Here, the control unit 110 preferably collects the AP information at least three different positions in relation to the same AP to calculate the location of the AP accurately.

In more detail, the control unit 110 activates the WLAN unit 180 periodically, or according to the user request, to acquire the AP information (AP identity information and RSSI) of at least one nearby AP when the mobile terminal 100 enters the AP location information acquisition mode. The AP information can include an unique identity information of the AP (e.g. MAC address) and the received signal strength (RSSI) of the AP. During the AP location information acquisition mode, the control unit 110 also can activate the sensor unit 160 to acquire the movement speed of the mobile station 100 by means of the acceleration sensor (not shown) and movement direction and time by means of the magnetic sensor and then generate the location information of the mobile terminal 100. That is, the control unit 110 can locate the position at which the AP is scanned by the mobile terminal 100 using DR. For this purpose, the control unit 110 can include the location estimator 10 for estimating the location of the mobile terminal 100 using the sensory values provided by the sensor unit 160. In case that the sensor unit 160 is not included, the location estimator 10 can produce the location information of the mobile terminal 100 by referring to a previously stored AP location information DB 20 using the scanned AP information(AP identity information and RSSI).

In case that no AP location information DB exists in the storage unit 120, the control unit 110 can receives the AP location information DB 20 from the location server 200 by means of the RF unit 150. The control unit 110 also can receive the AP location information DB 20 from another mobile terminal or local server installed at a building such as department store and shopping mall.

The control unit 110 also can calculate the distance from the AP based on the signal strength of the AP. In case that the AP information(AP identity information and RSSI) is acquired at the at least three positions in relation to the same AP, the control unit 110 can calculate the location of the AP using triangulation method. For this purpose, the control unit 110 can include an AP location calculator 11. In case that the AP location information DB is managed in the location server 200, the AP location calculator 11 can be incorporated into the location server. The AP location calculation method is described later with reference to FIG. 3.

Once the location of the AP is calculated using the above method, the control unit 110 can store the calculated location information of the AP in the AP location information DB 20. Here, the control unit 110 also can store the corresponding RSSI of the AP and the AP scan location information in the AP location information DB 20.

In case that the AP-based location information service is provided via the location server 200, the control unit can transmit the location information of the AP, AP identity information, RSSI, and AP scan location information to the location server 200 by means of the RF unit 150. In case that the AP location calculator 11 is included in the location server 200, the control unit 110 can transmit only the AP identity information, RSSI, and AP scan location information to the location server 200. As a result, the AP location information can be calculated by the location server 200.

Once the AP location information DB 20 is built successfully as described above, the control unit 110 can scan to acquire the information on the nearby APs and generate the location information of the mobile terminal 100 by referencing to the previously stored AP location information DB 20. In case that the AP location information DB 20 is managed in the location server 200, the control unit 110 can transmit the current location information of the mobile terminal 100 to the location server 200 and receive the AP location DB 20 related to the area corresponding to the current location information. The AP location information DB-based position location method of the mobile terminal can use the fingerprint location algorithm and triangulation algorithm. Since the fingerprint location algorithm is well known, a detailed description thereof is omitted herein.

In case that both the GPS signal and AP signal are not received, the control unit 110 activates the sensor unit 160 to locate the current position of the mobile terminal 100 using DR. In an alternate embodiment of the present invention, it is possible to apply a pedestrian DR (PDR) developed for the pedestrian mobility. Although the description is directed to the case where the AP location information DB 20 is generated by collecting the AP information when the mobile terminal 100 enters the AP location information acquisition mode, the present invention is not limited thereto. For example, when the mobile terminal 100 enters the GPS shadow area, the control unit 110 activates the AP location information acquisition mode and updates the AP location information DB 20 with the new acquired AP location information.

Although not depicted in FIG. 2, the mobile terminal 100 according to an embodiment of the present invention can further include at least one of a camera module for capturing still and motion pictures, a broadcast module for receiving broadcast signal, a digital audio playback module such as MP3 module, and an approach sensor for sensing object approaching, for supporting supplementary functions. Although not enumerated herein, other equivalents of the aforementioned components can be incorporated in the mobile terminal 100 selectively.

FIG. 3 is a flowchart illustrating a method for locating APs in a GPS shadow area according to an embodiment of the present invention, and FIG. 4 is a diagram illustrating the principle of locating an AP deployed in a GPS shadow area using triangulation according to an embodiment of the present invention.

Referring to FIGS. 1 to 4, the control unit 110 is monitoring to detect a signal and, if a signal is detected, determines whether the signal is a request for executing the AP location information acquisition mode (201). The AP location information acquisition mode can be executed by a user request or automatically when the mobile terminal 100 moves from a GPS available area to a GPS shadow area. If the signal is not the request for executing the AP location information acquisition mode, the control unit 110 controls to execute a function corresponding to the detected signal (215). For example, the control unit 110 can execute the audio playback function, video playback function, or photographing function in response to a user request.

If the signal is the request for executing the AP location information acquisition mode, the control unit 110 acquires reference location information (203). The reference location can be the last location at which the GPS signal is received when the AP location information acquisition mode is activated automatically due to the movement of the mobile terminal 100 from the GPS available area to the GPS shadow area. In case that the AP location information acquisition mode is activated by the user in the GPS shadow area, the reference location information can be manually input by the user. In case that the reference location is not determined, the user can move to the GPS available area to acquire the reference location and then execute the AP location information acquisition mode.

Once the reference location information has been acquired, the control unit 110 performs scan periodically to collect the AP information (AP identity information and RSSI) of at least one AP (205) and calculates and stores the AP scan location (207) using Dead Reckoning (DR). In more detail, the control unit 110 activates the WLAN unit 180 to perform scanning periodically to collect the AP information. The collected AP information can include RSSI and AP identity information (MAC address). While collecting the AP information, the control unit 110 can calculate and store the location at which the AP information is collected (AP scan location).

Since no GPS signal is received, the control unit 110 calculates the AP scan location using the Dead Reckoning (DR) with sensors. That is, the control unit 110 activates the sensor unit 160 to measure the movement speed and direction of the mobile terminal 100 and calculates the AP scan location based on the measurement result and the reference location information. For this purpose, the control unit 110 is provided with the location estimator 10, and the sensor unit 160 can includes an acceleration sensor for measuring the movement speed and a magnetic sensor and gyroscope for measuring the movement direction.

Although it is depicted that steps 205 and 207 are performed in series in FIG. 3, they can be performed simultaneously. Although the description is directed to the case where the acceleration sensor, gyroscope, and magnetic sensor are used for measuring the movement speed and direction of the mobile terminal 100, the present invention is not limited thereto. For example, the present invention can be implemented with any other type of sensor that is capable of measuring the movement speed and direction of an object.

After acquiring the AP scan location at step 207, the control unit 110 calculates the location of the AP using the periodically collected AP information and the AP scan location. For this purpose, the control unit 110 can include the AP location calculator 11. The AP location information calculation method is described in detail with reference to FIG. 4.

Referring to FIG. 4, if the AP is scanned at the at least three positions A1, A2, and A3, for example, the control unit 110 calculates the distances among the three positions based on the received signal strength measured at the respective positions and then determined the location information of the AP using the triangulation method, which uses the plural location information of the scan execution positions and the calculated distances. That is, the AP location calculator 11 of the control unit 110 can locate the AP at the position where the first circle with a radius R1 centering around the position A1, the second circle with a radius R2 centering around the position A2, and the third circle with a radius R3 centering around the position A3 are crossing.

Although one AP is depicted in FIG. 4, the present invention is not limited thereto. For example, when there are plural APs, the AP location calculator 11 of the control unit 110 identifies the individual APs with their identity information (MAC address) and collects the AP information at three different positions relative to each AP to calculate the location of the AP using triangulation.

Once the location information of the AP has been determined, the control unit 110 stores the determined AP location information and the corresponding the AP identity information in order to build the AP location information DB 20 (211). Here, the control unit 110 can further store the signal strength and AP scan location information matching the determined AP location information in the AP location information DB.

Next, the control unit 110 determines whether a request for terminating an AP location information acquisition mode is detected (213). If no AP location information acquisition mode termination request is detected, the procedure goes to step 205.

As described above, the AP location method is capable of building (creating and updating) the AP location information DB 20 including the location information of the APs located in the GPS shadow area. The control unit 110 further registers, if the located AP does not exist in the AP location information DB 20, the newly located AP with the AP location information DB 20, or updates, if the located AP exists in the AP location information DB 20, the location information of the corresponding AP especially when the location of the AP is changed.

Although the description is directed to the case where the AP information is collected periodically, the present invention is not limited thereto. For example, the AP information collection can be triggered by user's request. Although not described above, the location information can include the latitude and longitude information with or without height (altitude) information.

The method for building the AP location information DB for providing the location information service in the GPS shadow area has been described above. Hereinafter, a description is made of the method for providing the location information using the AP location information DB.

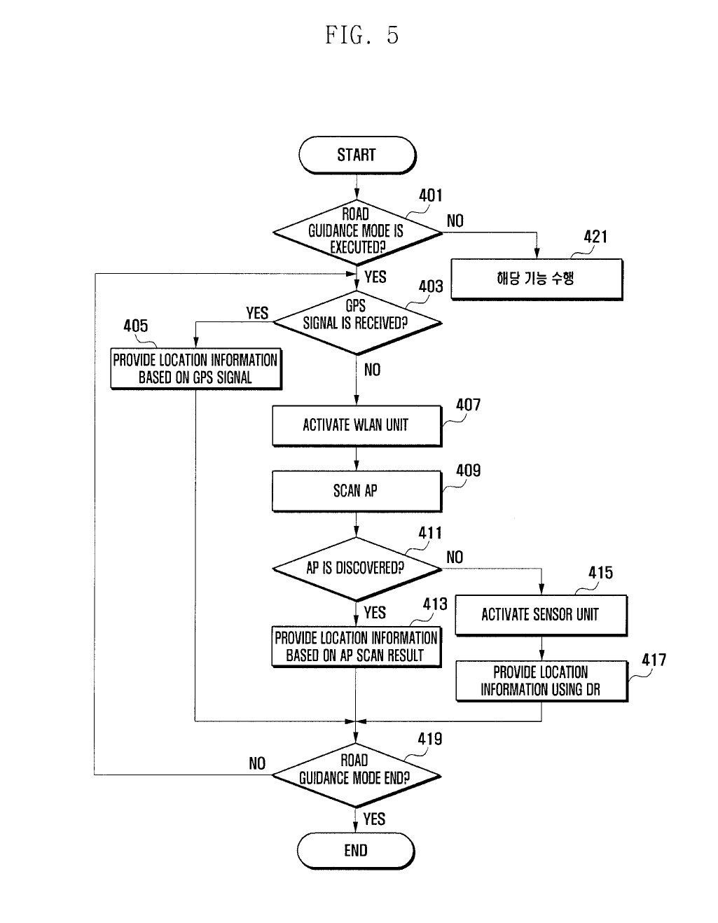

FIG. 5 is a flowchart illustrating a method for providing location information according to an embodiment of the present invention.

Referring to FIGS. 1 to 5, the control unit 110 is monitoring to detect a signal and, if a signal is detected, determines whether the signal is a request for executing a road guidance mode (401). If the signal is not the road guidance mode execution request, the control unit 110 controls to execute a function corresponding to the detected signal (421). For example, the control unit 110 can execute the digital broadcast play function, video call function, or photographing function in response to a user request.

If the signal is the road guidance mode execution request, the control unit 110 determines whether a GPS signal is received (403). If the GPS signal is received, the control unit 110 provides the location information based on the GPS signal (405). Otherwise, if no GPS signal is received at step 403, this means that the mobile terminal 100 is in a GPS shadow area, such that the control unit 110 activates the WLAN unit 180 (407) and performs scanning to discover APs around (409).

The control unit 110 determines whether any AP exists around the mobile terminal 100 as the scanning result (411). If it is determined that any AP exists around the mobile terminal 100, the control unit 110 provides the location information based on the AP scan result (413). In detail, when an AP exists in the GPS shadow area, the control unit 110 scans around to collect the AP information (signal strength and identity information of the AP) and compares the collected AP information with information in a previously stored AP location information DB 20 to calculate the current location of the mobile terminal 100. Here, the control unit can use one of the fingerprint location algorithm and triangulation location algorithm to produce the location information of the mobile terminal 100. Since the fingerprint location algorithm is well known, a detailed description thereof is omitted herein.

In case that the AP location information DB 20 is stored in the location server 200, the control unit 10 controls to transmit approximate current location information to the location server 200 and in turn receive information relating to the AP location information DB corresponding to the approximate location from the location server 200. Alternatively, the control unit 110 can control to transmit the collected AP information to the location server 200 and in turn receive the corresponding location information of the mobile terminal 100 from the location server 200 based on the AP location information DB 20.

If it is determined that no AP exists around the mobile terminal 100 at step 411, the control unit 110 activates the sensor unit 160 (416) and measures the movement speed and direction of the mobile terminal 100 by means of the sensor unit 160 to provide the location information calculated using DR based on the measured movement speed and direction (417) and the reference location information. For this purpose, the control unit 110 can sets the location where the last GPS signal is received as the reference location information. Further, the control unit 110 also can control such that a popup window prompting the user to enter coordinate information as the reference location.

The control unit 110 determines whether a request for terminating the road guidance mode (419). If no road guidance mode termination request is detected, the procedure goes to step 403.

As described above, the location information provision method of the present invention is capable of providing the user with an accurate location even in the GPS shadow area using the AP location information DB covering accurate locations of the APs installed in the GPS shadow area (e.g. department store, research center, subway shopping center, and tunnel). Thus, the location information provision method of the present invention is capable of providing seamless location information service. Also, inventive method is capable of locating a position where AP scan is executed with dead reckoning (DR) and calculating the location of the AP based on the AP scan location, whereby it is possible to build the more accurate AP location information DB even in the GPS shadow area.

Although not depicted in FIG. 5, when the mobile terminal 100 operating in the road guidance mode enters the GPS shadow area, the control unit 110 can execute the AP location information acquisition mode on background to update the AP location information DB 20 continuously. Thus, the control unit 110 registers, when the detected AP is a new AP, the new AP with the AP location information DB and updates, when the AP is a registered one, the location information of the AP.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although preferred embodiments of the method and system for building the AP location information DB and providing location information based on the AP location information DB has been described with reference to the drawings using specific terms, such description is to explain and help understand the subject matter of the present invention rather than of limitation. That is, it is obvious to those skilled in the art that various embodiments can be made or executed within the scope and concept of the present invention.

What is claimed is:

1. A method for building an Access Point (AP) location information database (DB) including in a Global Positioning System (GPS) shadow area using a mobile terminal, comprising:
acquiring a reference location during a location information acquisition mode;
periodically scanning for nearby APs to collect AP information of at least one AP;
calculating AP scan location where the periodic scanning is performed;
calculating AP location of the at least one AP using the AP information and the AP scan location; and
mapping the calculated AP location to the AP information in the AP location information DB for a storage.

2. The method of claim 1, further comprising storing the AP scan location and a corresponding signal strength of the at least one AP in the AP location information DB.

3. The method of claim 1, wherein calculating the AP scan location comprises measuring a location where the AP is scanned using one of Dead Reckoning (DR) and Pedestrian DR (PDR) in the GPS shadow area.

4. The method of claim 3, wherein measuring comprises:
measuring a movement speed and direction of the terminal using a sensor; and
determining the AP scan location based on the movement speed and the direction in relation to the reference location, the reference location being a last location at which the GPS signal is received or being manually input in the mobile terminal.

5. The method of claim 1, wherein calculating AP scan location comprises retrieving a location of the APs corresponding to the AP information from a pre-stored AP location information DB;
calculating a distance between APs and AP scan location based on a received signal strength of the APs, respectively; and
calculating the AP scan location using the retrieved location of the APs and the distance.

6. The method of claim 1, further comprising transmitting the AP location information DB to a location server.

7. The method of claim 1, further comprising transmitting the AP location information DB to another mobile terminal and receiving the AP location information DB from another mobile terminal.

8. A system for building an Access Point (AP) location information database (DB) including a GPS shadow area, comprising:
a mobile terminal periodically scanning to collect AP information of at least one AP when entering to the GPS shadow area and calculating an AP scan location where the periodic scanning is performed; and
a location server providing the AP location information DB using AP location derived from the AP information and the AP scan location.

9. The system of claim 8, wherein the mobile terminal comprises:
a Wireless Local Area Network (WLAN) unit scanning to detect at least one AP;
a sensor unit measuring a movement direction and speed of the mobile terminal;
a control unit acquiring a reference location during a location information acquisition mode, collecting the AP information of the at least one AP by scanning periodically, calculating the AP scan location; and
a Radio Frequency (RF) unit transmitting the AP information and the AP scan location to the location server.

10. The system of claim 9, wherein the mobile terminal further comprising:
an AP location calculator calculating the AP location of the at least one AP using the AP information and the AP scan location; and
a storage unit storing the AP location information DB containing a mapping of the AP location and the AP information.

11. The system of claim 9, wherein the mobile terminal further comprises a GPS unit which receives a GPS signal to acquire the reference location.

12. The system of claim 9, wherein the control unit comprises a location estimator estimating a location where the AP is scanned using one of Dead Reckoning (DR) and Pedestrian DR (PDR) in the GPS shadow area.

13. The system of claim 12, wherein the location estimator determines the AP scan location based on the movement speed and direction in relation to the reference location.

14. The system of claim 10, wherein the storage unit stores the AP scan location and a corresponding signal strength of the at least one AP.

15. The system of claim 9, wherein the RF unit performs one of transmitting the AP location information DB to another mobile terminal and receiving the AP location information DB from another mobile terminal.

16. A method for providing a mobile location information using an Access Point (AP) location information database (DB) including a Global Positioning System (GPS) shadow area, comprising:
determining, when a road guidance mode is executed, whether a GPS signal is received;
scanning, when no GPS signal is received, to discover a nearby AP by activating a Wireless Local Area Network (WLAN) unit;
collecting, when at least one AP is discovered, AP information of the at least one AP; and
providing location information of a mobile terminal by comparing the collected AP information to the AP location information DB.

17. The method of claim 16, wherein providing the location information comprises:
transmitting the collected AP information to a location server having the AP location information DB, and in response, receiving the location information of the mobile terminal from the location server.

18. The method of claim 16, wherein providing the location information comprises
retrieving a location information of at least AP corresponding to the collected AP information from the AP location information DB;
calculating a distance between at least one AP and the mobile terminal based on a received signal strength of at least one AP; and
calculating the location information of the mobile terminal using the retrieved location information of at least one AP and the distance.

19. The method of claim 18, further comprising one of transmitting the AP location information DB to another mobile terminal and receiving the AP location information DB from another mobile terminal.

20. The method of claim 16, wherein the AP information comprises identity information of the AP and a corresponding signal strength of the at least one AP.
